(19) United States
(12) Patent Application Publication
(10) Pub. No.: US 2020/0076009 A1
(43) Pub. Date: Mar. 5, 2020

(54) FIRE-RETARDANT BASED NANOFIBER COATED SEPARATORS FOR LI-ION BATTERIES AND PRODUCING METHOD THEREOF

(71) Applicant: Nano and Advanced Materials Institute Limited, Hong Kong (HK)

(72) Inventors: Chi Ho KWOK, Hong Kong (HK); Ka I LEE, Hong Kong (HK); Chenmin LIU, Hong Kong (HK); Ivan Ka Yu LAU, Hong Kong (HK)

(21) Appl. No.: 16/547,582

(22) Filed: Aug. 22, 2019

Related U.S. Application Data
(60) Provisional application No. 62/724,634, filed on Aug. 30, 2018.

(51) Int. Cl. H01M 10/42; H01M 10/0525; H01M 2/16; A62C 3/16; A62C 35/10

(52) U.S. Cl. CPC H01M 10/4235; H01M 10/0525; H01M 2/1686; H01M 2200/10; A62C 3/16; A62C 35/10; H01M 2/162

(57) ABSTRACT

Lithium ion batteries with improved fire resistance properties are described. The lithium ion battery includes a first electrode including a lithium compound and a second electrode. A separator is positioned between the first electrode and the second electrode and an electrolyte is provided. wherein the separator comprises at least a layer of polymeric nanofibers positioned on one side of a separator core and a fire-retardant polymer coating formed opposite to the nanofiber layer which is simultaneously deposited during electrospinning process. The polymeric nanofibers have a diameter less than approximately 1 micron. The polymeric nanofibers have a fire-retardant material entrapped within the nanofibers. The fire-retardant material has a lower melting point than the polymeric nanofibers. The separator/nanofibers/fire-retardant material are configured such that a fire-initiating event releases the entrapped fire-retardant material from the nanofibers which extinguishes the fire-initiating event.

### CROSS-REFERENCE TO RELATED APPLICATIONS

The present application claims priority from the U.S. provisional patent application Ser. No. 62/724,634 filed Aug. 30, 2018, and the disclosure of which is incorporated herein by reference in its entirety.

### FIELD OF THE INVENTION

The present invention relates to lithium ion batteries having fire-retardant nanofiber separators and, more particularly, to lithium ion batteries having fire-retardant separators in which the separator is configured such that a fire-initiating event releases entrapped fire-retardant material from the nanofibers and extinguishes the fire-initiating event.

### BACKGROUND

Lithium ion batteries are used in a wide variety of electronic devices such as computers, mobile phones, and electric vehicles. In addition to the current applications, lithium ion batteries are being considered for use in wearable electronics owning to their high energy densities, stable cycle performances, and light weight. With the increase in capacity loading requirement for different practical applications, the safety of lithium ion batteries has become a challenge to meet safety standards. It has been recognized that the liquid electrolytes are highly flammable in lithium ion batteries; typically, these electrolytes are organic based with low flash points making it easy for them to catch fire. Ethylene carbonate (EC) and diethyl carbonate (DEC) are commonly used electrolytes in lithium ion batteries. Damage to lithium ion batteries can create sparks that ignite these electrolyte materials.

Various approaches have been used to reduce the risk of fire in lithium ion batteries. Examples include ceramic coatings on the battery separator, applying thermo-responsive microsphere coatings on electrodes, or formulating flame-retardant additives into the electrolytes. These approaches have several shortcomings. For example, ceramic coatings may increase the overall battery weight while the addition of flame retardants to the electrolyte may affect the stability and ionic conductivity of the batteries.

One approach, set forth in US Published Patent Application 2004/0086782, uses an adjuvant with a battery separator. Any spark that forms (e.g., from an accident or from a foreign object penetrating the battery) causes the adjuvant to decompose, forming a gas that blows electrolyte away from the energy concentration to prevent initiation of a reaction. However, formation of a gas can be problematic within the tight confines of a battery. Therefore, there remains a need in the art for improved fire-resistant lithium ion batteries.

### BRIEF DESCRIPTION OF THE DRAWINGS

FIG. 1 schematically depicts a lithium ion battery incorporating a fire-retardant nanofiber and a fire-retardant polymer coating separator;

FIG. 2 is a photomicrograph of a fire-retardant nanofiber layer and a fire-retardant polymer coating on a separator formed during electrospinning process;

FIG. 3 depicts flame retardant particles intimately mixed in a polymer matrix in a nanofiber;

FIG. 4A depicts a nanofiber layer; FIG. 4B depicts composition of the nanofiber; FIG. 4C depicts a polymer layer while FIG. 4D depicts composition of the polymer layer on a separator;

FIGS. 5A, 5B, 5C, 5D, 5E and 5F depicts battery performance of several batteries, including their discharge capacity and charge-discharge cycles at the first 12 cycles at 0.5 C;

FIGS. 6A and 6B depict flame test results for a conventional separator (FIG. 6A) and a separator including a layer of fire-retardant nanofibers and a fire-retardant polymer coating (FIG. 6B);

FIG. 7 schematically depicts a nail penetration test for a battery;

FIG. 8A shows the temperature profile for a control battery; FIG. 8B shows the temperature profile for a battery with a flame-retardant nanofiber layer-coated separator and a fire-retardant layer of polymer coating in a flame test.

FIGS. 9A-9F depict tests and results of nail penetration tests for conventional separator batteries (FIGS. 9A-9C) and flame-retardant nanofiber with a layer of fire-retardant polymer coating separator batteries (FIG. 9D-9F);

FIG. 10 depicts the capacity vs. cycles for a conventional battery and a battery with a flame-retardant nanofiber with a fire-retardant polymer coating separator.

FIG. 11 is a temperature profile of two 3 Ah batteries during a nail penetration test with ME26 being without a flame-retardant nanofiber layer and ME27 having a flame-retardant nanofiber and polymer layer;

FIG. 12 is a photo of a 3 Ah battery change before and after nail penetration test for samples without the flame-retardant nanofiber layer (top) and samples with the flame-retardant nanofiber with a fire-retardant polymer coating (bottom).

### SUMMARY OF THE INVENTION

The present invention provides lithium ion batteries with improved fire resistance properties. The lithium ion battery includes a first electrode including a lithium compound and a second electrode. A separator is positioned between the first electrode and the second electrode and an electrolyte is provided. The separator comprises at least a layer of polymeric nanofibers positioned on a separator core, each nanofiber having a diameter less than approximately 1 micron. The polymeric nanofibers have a fire-retardant material entrapped within the nanofibers. The fire-retardant material has a lower melting point than the polymeric nanofibers. In addition, a polymer coating is positioned on the other side of the separator core, the polymer coating being simultaneously deposited during an electrospinning process that deposits the polymeric nanofibers. The separator/nanofibers/fire-retardant materials are configured such that a fire-initiating event releases the entrapped fire-retardant material from the nanofibers which extinguishes the fire-initiating event.

### DETAILED DESCRIPTION OF THE INVENTION

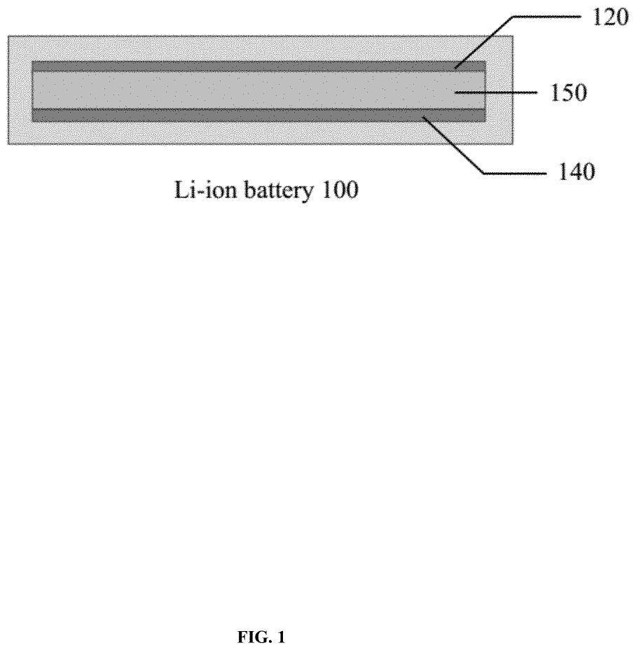

A lithium ion battery is formed incorporating a fire-retardant nanofiber separator. The lithium ion battery is schematically depicted in FIG. 1. Lithium ion battery 100 includes a first, positive electrode 120 that incorporates a lithium-containing compound such as lithium cobalt oxide, lithium manganese oxide, lithium nickel manganese cobalt oxide, lithium iron phosphate, lithium nickel cobalt aluminum oxide, or any other lithium-based positive electrode material. A negative electrode 140 is provided and may include graphite or other carbon, silicon, or silicon/carbon materials, or tin/cobalt alloys or any other material that can accommodate lithium ions from the positive electrode. The separator 150 includes nanofibers with entrapped first-retardant material that is released during a fire-initiating event. An electrolyte is provided that facilitates the movement of ions between the electrode (with the direction of ion movement dictated by whether the battery is charging or discharging). Electrolytes may include lithium salts in organic solvents such as ethylene carbonate, dimethyl carbonate, or diethyl carbonate. These organic solvents are also flammable, thus suppression of fire-initiating event by the fire-retardant material enhances the safety of the resultant lithium ion battery.

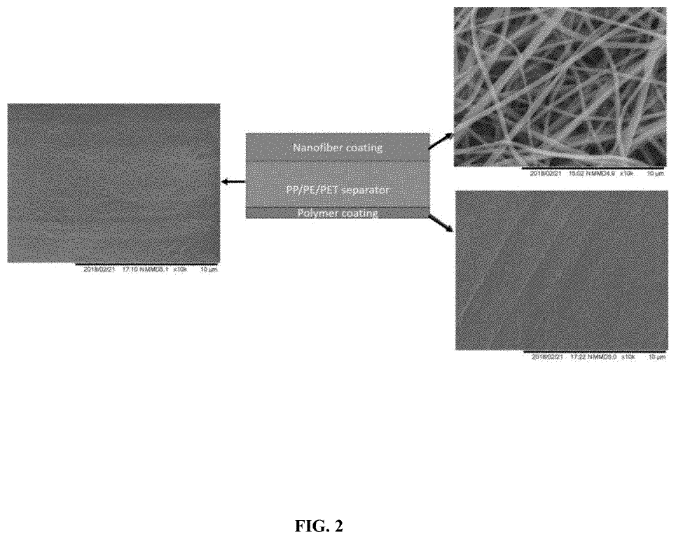

The separator 150 may be a composite separator as shown in FIG. 2. In the composite separator of FIG. 2, a layer of fire-retardant nanofibers forms a single layer on a conventional separator that acts as the separator core. The conventional separator core may be selected from any commercially-available separator or may be custom-made for the present application. There is no limitation on the use of material on the separator; any separator material may be used including, but not limited to polypropylene, polyethylene, polyethylene terephthalate, or polyimide. That is, any separators that are compatible with lithium-ion batteries and compatible with the fire-retardant nanofibers may be used as the separator core. In one aspect, the nanofibers may be deposited by electrospinning to form a nonwoven nanofiber layer having a thickness of approximately 5 microns to approximately 30 microns. The nanofibers compositions and deposition techniques may be selected from those described in copending U.S. Ser. No. 15/178,631, the disclosure of which is incorporated by reference herein.

To create fire-retardant nanofibers, fire-retardant materials are added to a polymer composition and formed into fibers. The polymer composition may be selected from a variety of polymeric materials as long as the material is capable of being formed into fibers as by, for example, electrospinning. The polymers may be selected from poly(vinylidene fluoride), polyimide, polyamide and polyacrylonitrile with an optional second material polyethylene glycol, polyacrylonitrile, poly(ethylene terephthalate), poly(vinylidene fluoride), poly(vinylidene fluoride-hexafluoropropylene) and poly(vinylidene fluoride-co-chlorotrifluoroethylene). Exemplary compositions discussed in more detail below include polyvinylidene fluoride (PVDF) and composites of polyvinylidene fluoride and hexafluoropropylene (HFP). Exemplary fire retardants include non-halogenated phosphoric acid esters, non-halogenated phosphoric acid polyesters, halogenated phosphoric acid esters and halogenated phosphoric acid polyesters. Particular fire-retardant materials include trimethyl phosphate, triethyl phosphate, triphenyl phosphate, tricresyl phosphate, trixylenyl phosphate, or cresyl diphenyl phosphate; however, other fire-retardant materials may also be used. The ratio of polymer to flame-retardant material ranges, in one aspect, from 5:1 to 1:1, or, in another embodiment, from 4:1 to 2:1, or, in another embodiment from 2:1 to 1:2.

As seen in FIG. 2, a polymer layer is disposed on a surface of the separator opposite from the polymer nanofiber layer. The polymer layer may have a thickness ranging from 3-8 microns. The polymer layer may be the same composition as the polymer nanofiber layer or may be a different composition. The polymer of the polymer layer may be selected from poly(vinylidene fluoride), polyimide, polyamide and polyacrylonitrile with an optional second material polyethylene glycol, polyacrylonitrile, poly(ethylene terephthalate), poly(vinylidene fluoride), poly(vinylidene fluoride-hexafluoropropylene) and poly(vinylidene fluoride-co-chlorotrifluoroethylene). As with the polymer nanofiber layer, the polymer layer may include a fire-retardant material such as non-halogenated phosphoric acid esters, non-halogenated phosphoric acid polyesters, halogenated phosphoric acid esters and halogenated phosphoric acid polyesters. Particular fire-retardant materials include trimethyl phosphate, triethyl phosphate, triphenyl phosphate, tricresyl phosphate, trixylenyl phosphate, or cresyl diphenyl phosphate; however, other fire-retardant materials may also be used. The ratio of polymer to flame-retardant material ranges, in one aspect, from 5:1 to 1:1, or, in another embodiment, from 4:1 to 2:1, or, in another embodiment from 2:1 to 1:2.

In one aspect, the polymer layer may be deposited at the same time as the electrospun polymer nanofibers. In another aspect, the polymer layer may be deposited before or after the electrospun polymer nanofibers.

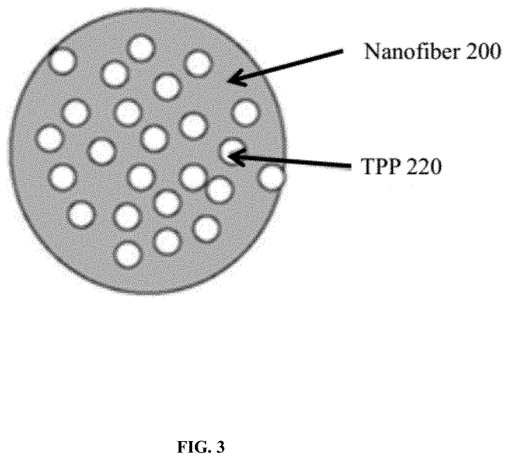

In one aspect, the fire retardants may be encapsulated within the fibers as depicted in FIG. 3. In FIG. 3, a nanofiber cross-section 200 is depicted with a fire-retardant such as triphenyl phosphate (TPP), dispersed within a polymer matrix within the fiber 200 as particles 220. Note that the techniques of the present invention create a uniform dispersion of fire-retardant particles within a polymer matrix. By forming this uniform dispersion, the fire-retardant particles are more easily liberated from the polymer matrix to extinguish a fire event in the battery.

The fire-retardant nanofibers may be formed by a variety of techniques such as electrospinning, hot-melt spinning, wet spinning, pipe spinnerets, wire spinning, nozzles spinning, or jet spinning. When being formed by electrospinning, the fire-retardant nanofibers may be formed according to the following: adding the selected one or more polymer materials and the selected fire retardant into a solvent. The solvent may be one or more of N-methyl-2-pyrrolidone (NMP), N,N-dimethylacetamide (DMAC), N,N-dimethylformamide (DMF), dimethyl sulfoxide (DMSO), acetone and tetrahydrofuran (THF). The mixture is heated at around 80-100° C. with stirring for about 2-5 hours. As a result, the fire-retardant composition is intimately mixed with the polymer such that a dispersion of fire-retardant particles are uniformly interspersed within a polymer matrix The polymer formulation solution may be cooled to room temperature and loaded into an electrospinning apparatus. Electrospinning may be performed under the following parameters: Temperature: about 20-35° C.; Voltage: about 20-50 kV; Relative humidity (RH): about 25-60%; Spinner height: 100-150 mm; and Feed rate: 400-600 ml/h. The formed fire-retardant nanofiber has a diameter less than one micron, more particularly between 10 and about 300 nm and even more particularly, 100 nm to about 300 nm. The fire-retardant nanofiber layer separator may have a porosity of about 60% to about 90% with an average pore size on the order of less than 1 μm.

The fire-retardant nanofibers are configured such that a fire-initiating event releases the entrapped fire-retardant material from the nanofibers and extinguishes the fire-initiating event. In particular, the fire-retardant material is released from the nanofibers when thermal stress is applied ranging from ±50° C. melting point or glass transition temperature of the polymeric nanofibers. At this temperature, the fire-retardant material escapes from the fiber and is free to act upon the fire-initiating event.

The below examples give details of fabrication and testing for batteries incorporating the fire-retardant nanofibers described above.

### Example 1: Separator Fabrication

A polymer composite of polyvinylidene fluoride and hexafluoropropylene (HFP) is prepared by heating in a solvent. A fire-retarding material, triphenyl phosphate (TPP), is added into the polymer solution and well mixed by overhead stirrer for at least 1-2 hours until all the TPP is completely dissolved at room temperature. The solution is then loaded into an electrospinning apparatus for electrospinning. The fire-retardant nanofibers are deposited on different type of substrates, including commercially-available polymer separators (by dry/wet process), ceramic-coated polymer separators, or hot melt spinning separators. The thickness of the nanofibers may be selected to be in the range of 1 um to 100 um, by selecting the speed of the roll-to-roll collector system. Materials and process parameters are set forth in Table 1 below:

TABLE 1
Processing parameter-electrospinning

| | High | Collector | | | | Roll-to-roll | |
|---|---|---|---|---|---|---|---|
| | Voltage | Voltage | Polymer | Fire | Pipe | speed mm/min | Substrate type |
| | kV | kV | solution | retardant | spinneret | (thickness) | (thickness) |
| Sample-1 | +40 | −10 | PVDF | TPP | 4 | 450 (20 um) | PP (7 um) |
| Sample-2 | +40 | −10 | PVDF + PVDF- | TPP | 4 | 450 (20 um) | PP (9 um) |
| | | | HFP | | | | |
| Sample-3 | +40 | −10 | PVDF-HFP | TPP | 4 | 450 (20 um) | PP (7 um) + |
| | | | | | | | ceramic coating |
| | | | | | | | (3 um) |

It was determined that the flame-retardant nanofibers are independent of the selected separator substrate and selected polymeric materials of the nanofibers.

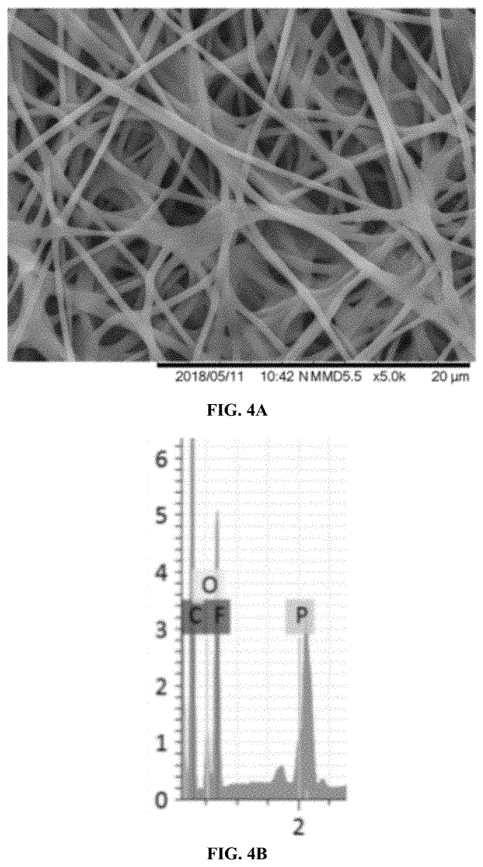

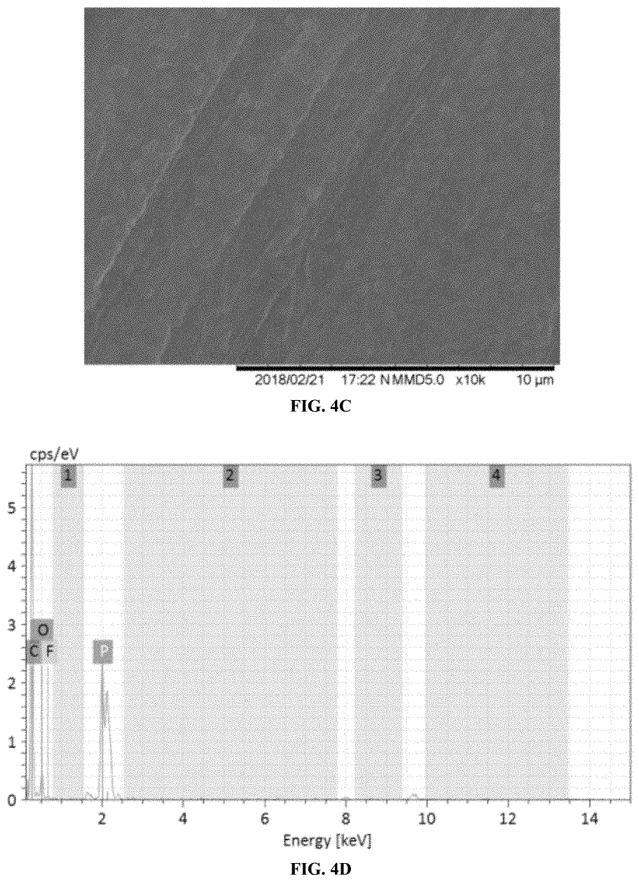

FIG. 4A depicts a scanning electron microscope (SEM) image and FIG. 4B and table 2 depict an energy-dispersive x-ray spectroscopy pattern (EDX) of fire-retardant nanofibers. FIG. 4C depicts a scanning electron microscope (SEM) image and FIG. 4D and table 3 depict an energy-dispersive x-ray spectroscopy pattern (EDX) of polymer coating. The EDX result shows the phosphorus (P) signal which indicated the existence of TPP in the nanofibers as phosphorus is not otherwise present in the separator polymer formulations.

TABLE 2
The results of energy-dispersive x-ray spectroscopy
pattern (EDX) of fire-retardant nanofibers

| | | | Mass | | abs. | |
|---|---|---|---|---|---|---|
| | | Mass | Norm. | Atom | error (%) | rel. error (%) |
| Element | At. No. | (%) | (%) | (%) | (1 sigma) | (1 sigma) |
| C | 6 | 53.86 | 53.86 | 64.36 | 6.52 | 12.10 |
| O | 8 | 11.59 | 11.59 | 10.40 | 1.75 | 15.13 |
| F | 9 | 31.61 | 31.61 | 23.88 | 3.94 | 12.45 |
| P | 15 | 2.94 | 2.94 | 1.36 | 0.14 | 4.85 |
| | | 100.00 | 100.00 | 100.00 | | |

TABLE 3
The results of energy-dispersive x-ray spectroscopy pattern (EDX) of
polymer coating

| | | | Mass | | abs. | |
|---|---|---|---|---|---|---|
| | | Mass | Norm. | Atom | error (%) | rel. error (%) |
| Element | At. No. | (%) | (%) | (%) | (1 sigma) | (1 sigma) |
| C | 6 | 77.96 | 77.96 | 85.68 | 10.49 | 13.45 |
| O | 8 | 11.78 | 11.78 | 9.72 | 2.56 | 21.74 |
| P | 15 | 9.39 | 9.39 | 4.00 | 0.40 | 4.29 |
| F | 9 | 0.88 | 0.88 | 0.61 | 0.39 | 44.73 |
| | | 100.00 | 100.00 | 100.00 | | |

### Example 2: Battery Performance Study

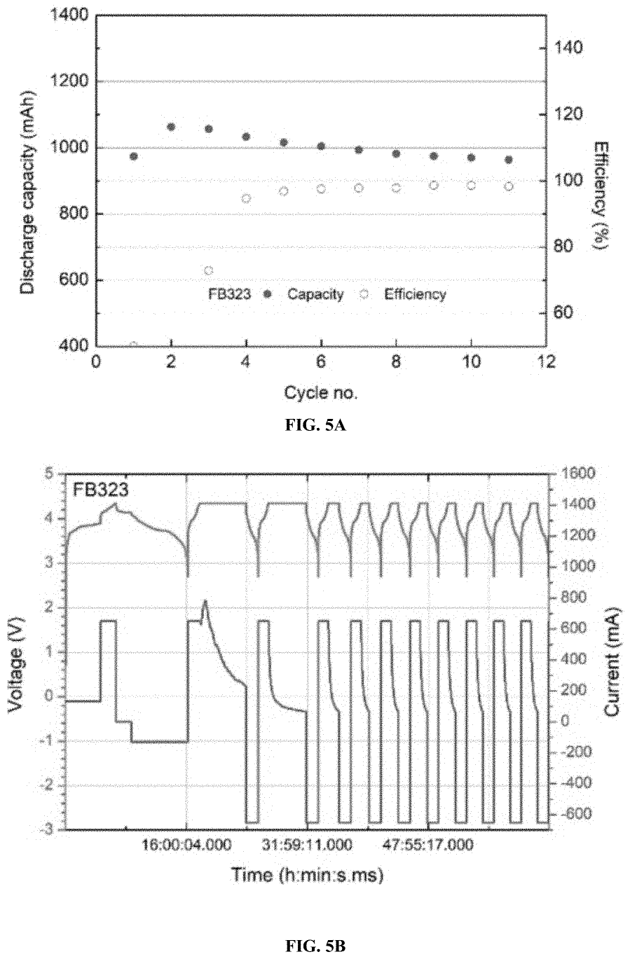

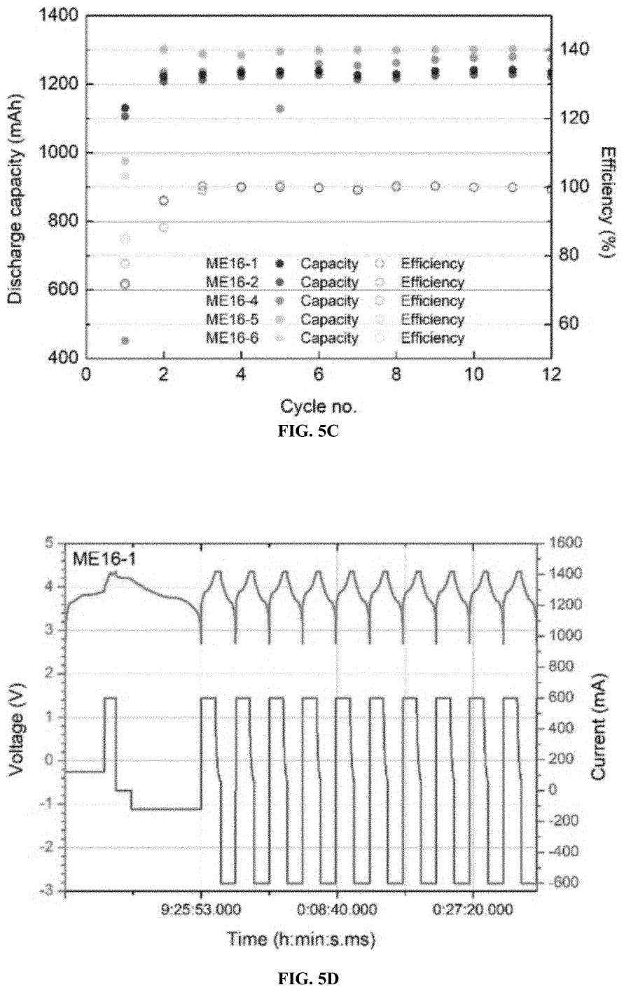

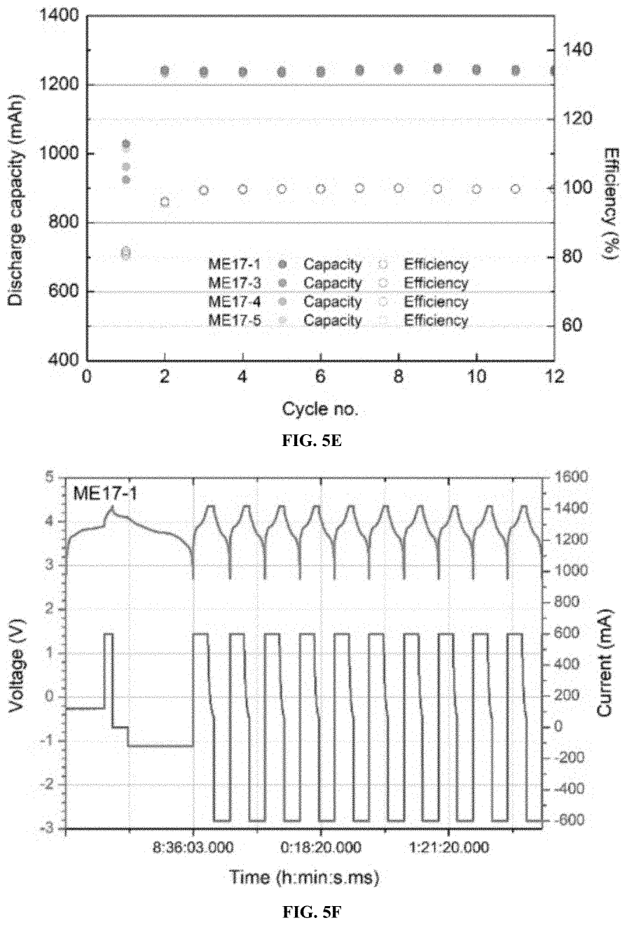

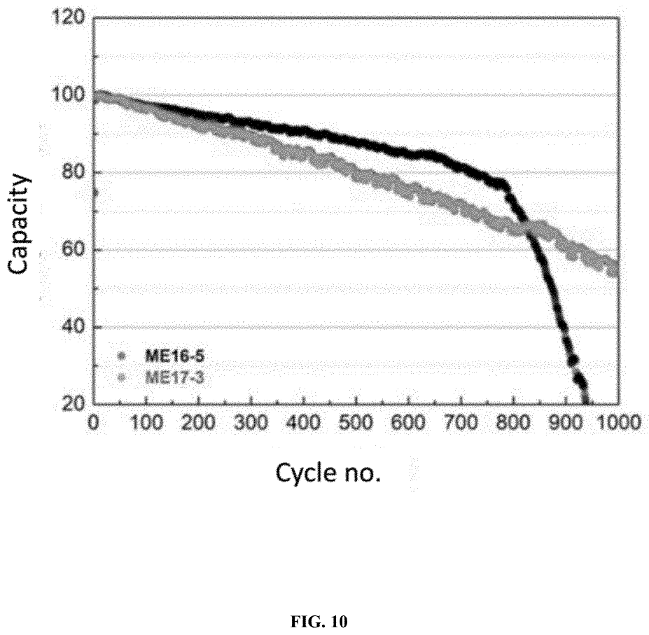

The flame-retardant nanofiber separators of Example 1 were incorporated into several 1 Ah lithium ion batteries. A similar number of control batteries having conventional separators were also formed. Both sets of batteries were subjected to charge/discharge cycles. The batteries' performance is summarized in Tables 4 and 5 and graphically depicted in FIGS. 5A-5F. FIGS. 5A and 5B depict the cycling performance and charge-discharge curves of a battery with 10 wt % flame retardant added in the electrolyte. FIG. 5C-5D depict the cycling performance and charge-discharge curves of a battery using a conventional commercial separator while FIGS. 5E-5F depict the cycling performance and charge-discharge curves of a battery using the fire-retardant nanofiber separators. The battery performance of the battery with flame retardant materials directly mixed in the electrolyte showed a lower discharge capacity and worse cycling performance than the battery using commercial separator (ME16) and with flame retardant nanofiber coated separator (ME17). It showed there was no flame retardant leakage from the flame retardant nanofiber coating that would affect the battery performance. FIG. 10 depicts the long-cycling performance of a control battery without a flame-retardant nanofiber layer compared to a battery with a flame-retardant nanofiber layer (sample no, ME-17-3) at 0.5 C. As seen in this FIG., the battery with the flame-retardant nanofiber layer has a higher capacity at large number of cycles while the conventional battery fails at approximately 950 cycles.

TABLE 4
Control Batteries' Performance:

| | | | | | | |
|---|---|---|---|---|---|---|
| | Battery | | Battery | | | |
| | capacity/ | | Size | Charging | | |
| Sample No. | mAh | Voltage/V | (L * W * H cm) | cycles | Retention | Impedance/(mΩ) |

10% fire retardant in electrolyte

| | | | |
|---|---|---|---|
| FB322 | 970 | 5.3 * 3.5 * 0.538 | 52.0 |

Without fire retardant nanofiber layer

| | | | | | | |
|---|---|---|---|---|---|---|
| ME 16-1 | 1241.6 | 4.32 | 5.1 * 4.2 * 0.487 | 14 | 99.4 | 29.27 |
| ME 16-2 | 1228.4 | 4.32 | 5.1 * 4.2 * 0.485 | 14 | 99.1 | 29.56 |
| ME 16-4 | 1277.5 | 4.32 | 5.1 * 4.2 * 0.487 | 14 | 99.2 | 30.54 |
| ME 16-5 | 1300.4 | 4.32 | 5.1 * 4.2 * 0.482 | 14 | 100.2 | 29.63 |
| ME 16-6 | 1303.4 | 4.32 | 5.1 * 4.2 * 0.481 | 14 | 100.2 | 29.98 |

TABLE 5
Batteries With Fire-Retardant Nanofiber Layer Separators'
Performance:

| | Battery | | Battery | | | |
|---|---|---|---|---|---|---|
| Sample | capacity/ | | Size | Charging | | |
| No | mAh | Voltage/V | (L * W * H cm) | cycles | Retention | Impedance/(mΩ) |
| ME17-1 | 1247.1 | 4.30 V | 4.3 * 5 * 0.519 | 14 | 99.5 | 33.0 |
| ME17-3 | 1241.9 | 4.30 V | 4.3 * 5 * 0.517 | 14 | 99.6 | 21.8 |
| ME17-4 | 1240.0 | 4.30 V | 4.3 * 5 * 0.518 | 14 | 99.5 | 32.6 |
| ME17-5 | 1238.2 | 4.30 V | 4.3 * 5 * 0.517 | 14 | 99.4 | 32.5 |

### Example 3: Flame Test

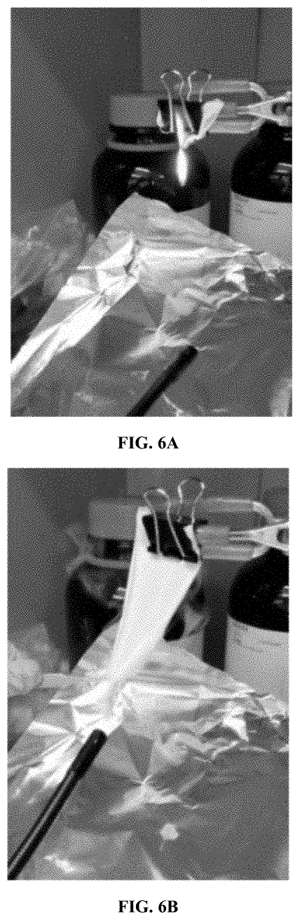

Conventional (control) separators were evaluated by the flame test along with the flame-retardant nanofiber separators. Each separator was subjected to an open flame under the same conditions. It was found that the separator without flame-retardant nanofibers quickly shrank and fire was found during the process (FIG. 6A). In contrast, the separator with fire-retardant nanofibers only exhibited smoke during the testing process and no fire ash was found (FIG. 6B).

### Example 4 (Nail Penetration Test-Thermal Runaway)

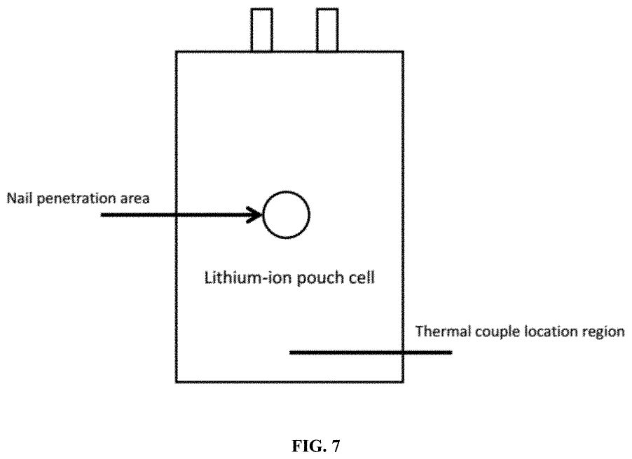

The safety of batteries incorporating the flame-retardant nanofibers was confirmed by a nail penetration test. The nail penetration test involves driving a metallic, electrically-conductive nail through a fully charged cell at a prescribed speed. Passing criteria include a lack of smoke, no flame and no leakage of electrolyte during and after the nail penetration test. FIG. 7 depicts a lithium-ion pouch-type battery showing the location of the nail penetration test and the location of the thermocouple. Table 6 lists the processing parameters of the nail penetration test.

TABLE 6
Parameters of Nail Penetration Test

| Parameter | Value | |
|---|---|---|
| Stroke | 150-200 | mm |
| Pressure | 12 | kg/cm² |
| Speed | 5 | mm/s |
| Load | 8.3 | N |
| Needle Diameter | 3 | mm |

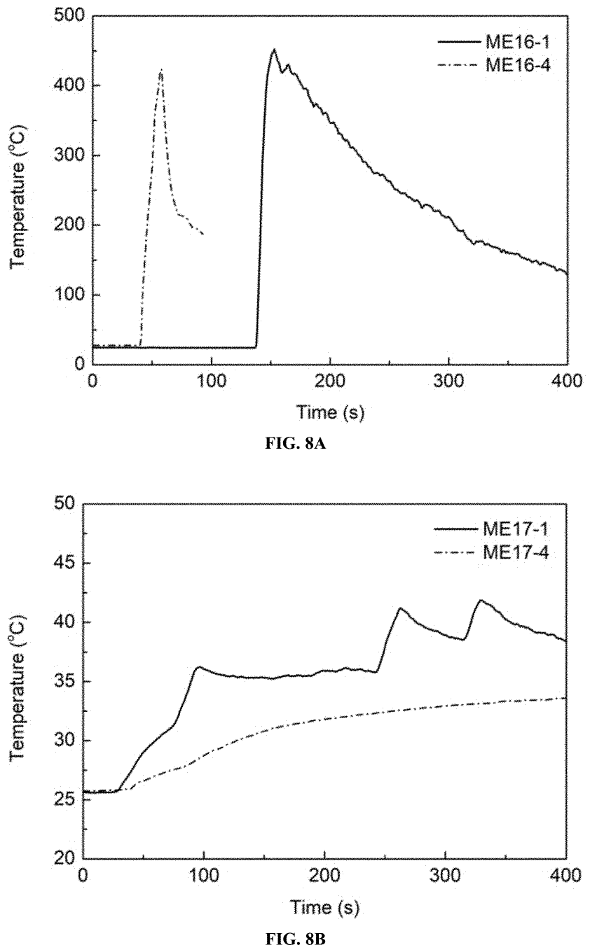

Two sets of batteries were used to simulate the thermal runaway condition with 1 set (2 pieces) of batteries having flame-retardant nanofiber separators and the other set (2 pieces) of batteries having conventional, commercially-available polypropylene separators. Both sets of batteries are prepared under the same condition and same charge/discharge cycles. Tables 7-9 show the details of test results for the control batteries and batteries having flame-retardant nanofiber separators, respectively. FIG. 8A shows the temperature profile for a control battery while FIG. 8B shows the temperature profile for a battery with a flame-retardant nanofiber separator.

TABLE 7
Control Battery (conventional separator-failed):

| | | | Discharge | Capacity | | Impedance | Max. |
|---|---|---|---|---|---|---|---|
| | | Battery size | Capacity | density | Voltage | Before | Temp |
| Cell no. | Separator | (L * W * H cm) | (10^{th} cycle) | (Wh/L) | (V) | (mΩ) | (° C.) |
| ME16-1 | 9 um (without | 5.1 * 4.2 * 0.487 | 1241.6 mAh | 514.2 | 4.32 | 29.27 | 451.9 |
| ME16-4 | flame retardant | 5.1 * 4.3 * 0.474 | 1277.5 mAh | 530.9 | 4.32 | 30.54 | 423.2 |
| | NFs coating) | | | | | | |

TABLE 8
Battery with Flame-Retardant Nanofiber Separator and fire-retardant
layer of polymer coating (passed):

| | | Battery size | Discharge | Capacity | | Impedance | Max. |
|---|---|---|---|---|---|---|---|
| | | (L * W * H | Capacity | density | Voltage | Before | Temp |
| Cell no. | Separator | cm) | (10^{th} cycle) | (Wh/L) | (V) | (mΩ) | (° C.) |
| ME17-1 | 9 um (with flame | 4.3 * 5 * 0.519 | 1247.1 mAh | 480.6 | 4.30 | 33.01 | 35.8 |
| ME17-4 | retardant NFs | 4.3 * 5 * 0.518 | 1240.0 mAh | 478.8 | 4.30 | 32.63 | 37.1 |
| | coating and fire- | | | | | | |
| | retardant layer of | | | | | | |
| | polymer coating) | | | | | | |

TABLE 9
Results for Control and Fire-Retardant Batteries

| | Max. Temp | |
|---|---|---|
| Cell no. | (° C.) | Results |
| ME16-1 | 451.9 | Failed (Smoke → Temperature increase → |
| | | Electrolyte leakage → Fire → Swell and |
| | | explosion) |
| ME16-4 | 423.2 | Failed (Smoke → Temperature increase → |
| | | Electrolyte leakage → Fire → Swell and |
| | | explosion) |
| ME17-1 | 35.8 | Pass (No smoke, <15° C. temperature increase, |
| | | no leakage of electrolyte, no fire and explosion) |
| ME17-4 | 37.1 | Pass (No smoke, <15° C. temperature increase, |
| | | no leakage of electrolyte, no fire and explosion) |

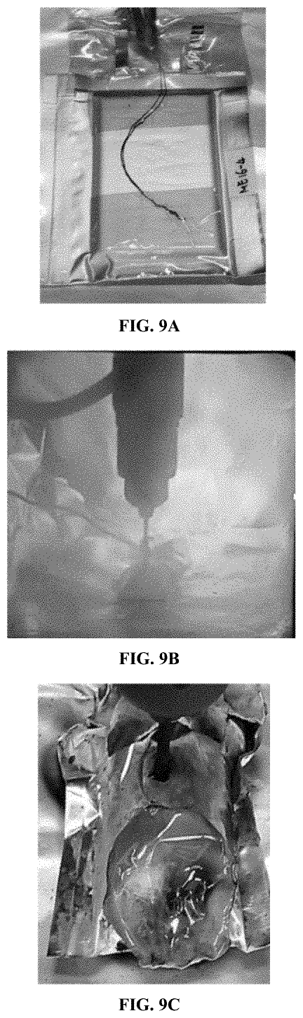

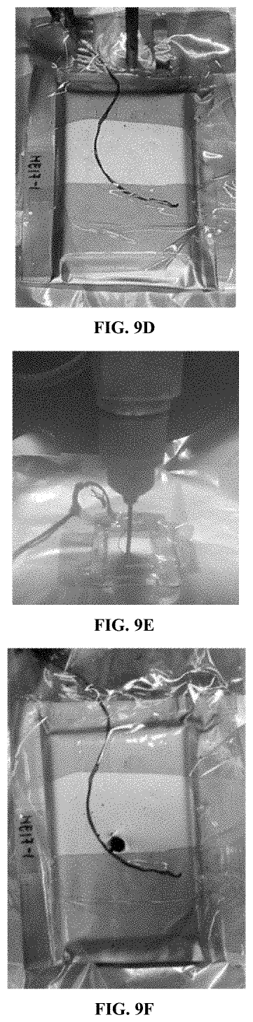

FIG. 9A shows a control battery (conventional separator) while FIG. 9D shows the inventive battery (fire-retardant nanofiber separator). FIG. 9B and FIG. 9E show nail penetration tests on the respective batteries while FIG. 9C and FIG. 9F show the results of the nail penetration tests. From the test results, it was determined that the batteries having conventional separators all fail, exhibiting black smoke and having a temperature ramp up to >400° C. in a short period of time, followed by electrolyte leakage and catching fire. Eventually the conventional batteries swell and explode. In contrast, the batteries including flame-retardant nanofibers do not exhibit any negative responses to the nail penetration test. The temperature slightly increases to 37° C. from room temperature. The batteries including flame-retardant nanofiber layers do not release smoke or leak electrolyte and there is no fire and swelling after the nail penetrated into the batteries. Thus, the batteries including flame-retardant nanofibers pass the nail penetration test.

### Example 5 (Higher Capacity Battery Nail Penetration Test)

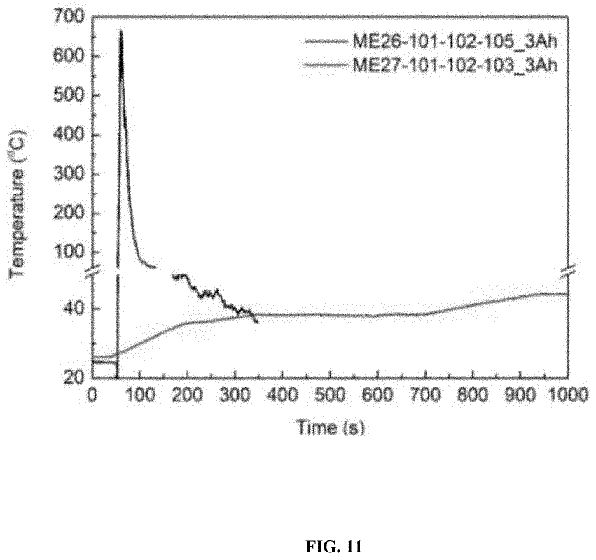

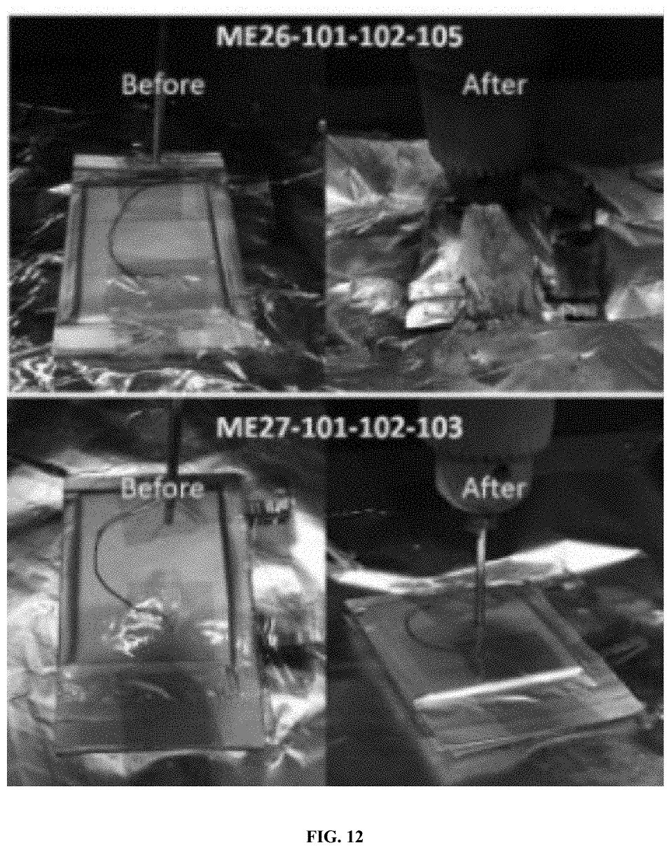

Two sets of batteries with a higher capacity of 3 Ah were prepared. One set of batteries included a flame retardant nanofiber coated separator and the other set of batteries included a commercially-available ceramic coated polypropylene separator. Both sets of batteries were fabricated under the same conditions. Three parts of 1 Ah battery were connected in series to prepare a battery with 3 Ah capacity. Tables 10 and 11 and FIGS. 11-12 show the details of test results and temperature profiles for both sets of batteries. As seen in FIG. 11, the sample without the flame-retardant nanofiber layer has an extreme spike in temperature and then fails while the sample with the flame-retardant nanofiber layer showed a small rise in temperature. FIG. 12 shows the catastrophic failure of the sample without the flame-retardant nanofiber layer while the sample with the flame-retardant nanofiber layer is intact.

TABLE 10
Control batteries without flame retardant nanofiber coating (failed)

| | | | Discharge | Capacity | | | Max. |
|---|---|---|---|---|---|---|---|
| | | Battery size | Capacity at 10^{th} | density | Voltage | Impedance | Temp |
| Cell no. | Separator | (L * W * H cm) | cycle (mAh) | (Wh/L) | (V) | (mΩ) | (° C.) |
| ME26- | 9 um coated | 4.9 * 7.8 * 0.255 | 1041.8 | 461.8 | 4.32 | 32.3 | 665.1 |
| 101 | with | | | | | | |
| ME26- | ceramics | 5.0 * 7.7 * 0.234 | 1054.4 | 505.0 | 4.30 | 34.2 | |
| 102 | | | | | | | |
| ME26- | | 5.0 * 7.8 * 0.253 | 1026.1 | 448.0 | 4.30 | 64.3 | |
| 105 | | | | | | | |

TABLE 11
Batteries with flame retardant nanofiber coating and fire-retardant layer
of polymer coating (passed)

| | | | Discharge | Capacity | | | Max. |
|---|---|---|---|---|---|---|---|
| Cell | | Battery size | Capacity at 10^{th} | density | Voltage | Impedance | Temp |
| no. | Separator | (L * W * H cm) | cycle (mAh) | (Wh/L) | (V) | (mΩ) | (° C.) |
| ME27- | 9 um | 5.1 * 7.8 * 0.264 | 986.9 | 401.3 | 4.30 | 44.2 | 44.5 |
| 101 | coated with | | | | | | |
| ME27- | ceramics | 5.1 * 7.6 * 0.259 | 1023.6 | 435.4 | 4.30 | 40.8 | |
| 102 | (with flame | | | | | | |
| ME27- | retardant | 5.1 * 7.6 * 0.257 | 1040 | 446.9 | 4.30 | 41.2 | |
| 103 | NFs | | | | | | |
| | coating and | | | | | | |
| | fire- | | | | | | |
| | retardant | | | | | | |
| | layer of | | | | | | |
| | polymer | | | | | | |
| | coating) | | | | | | |

It should be apparent to those skilled in the art that many modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “includes”, “including”, “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A lithium ion battery capable of withstanding nail penetration comprising:
a first electrode including a lithium compound;
a second electrode;
a separator positioned between the first electrode and the second electrode;
an electrolyte;
wherein the separator comprises at least a layer of electrospun polymeric nanofibers positioned on one side of a separator core, the separator core being selected from a polypropylene, polyethylene, or polyethylene terephthalate separator core, a polymer coating being positioned on another side of the separator core, the polymer coating being deposited during an electrospinning process that deposits the polymeric nanofibers, each nanofiber of the polymeric nanofibers positioned on the separator core having a diameter less than approximately 1 micron, the polymeric nanofibers and the polymer coating including a fire-retardant material, the fire-retardant material having a lower melting point than the polymeric nanofibers, the separator configured such that a fire-initiating event releases the fire-retardant material from the nanofibers and extinguishes the fire-initiating event.

2. The lithium ion battery as recited in claim 1, wherein the fire-retardant material is selected from one or more of trimethyl phosphate, triethyl phosphate, triphenyl phosphate, tricresyl phosphate, trixylenyl phosphate, or cresyl diphenyl phosphate.

3. The lithium ion battery as recited in claim 1, wherein the nanofibers are spun nanofibers produced by electro-spinning, hot-melt spinning, or wet spinning.

4. The lithium ion battery as recited in claim 1, wherein each nanofiber has a diameter ranging from 10 nm to 100 nm.

5. The lithium ion battery as recited in claim 1, wherein the ratio of polymer to flame-retardant material ranges from 5:1 to 1:1.

6. The lithium ion battery as recited in claim 1, wherein the ratio of polymer to flame-retardant material ranges from 4:1 to 2:1.

7. The lithium ion battery as recited in claim 1, wherein the ratio of polymer to flame-retardant material ranges from 1:1 to 1:2.

8. The lithium ion battery as recited in claim 1, wherein the layer of nanofibers has a thickness ranging from 1 um to 50 um.

9. The lithium ion battery as recited in claim 1, wherein a polymer for the polymeric nanofibers is selected from one or more of polyester, polypropylene, or polyvinylidene fluoride.

10. The lithium ion battery as recited in claim 1, wherein the fire-retardant material is released from the polymeric nanofibers when thermal stress is applied ranging from +50° C. of a melting point or glass transition temperature of the polymeric nanofibers.

11. The lithium ion battery as recited in claim 1, wherein the polymer coating on the separator has a thickness of 3-8 microns.
